(19) United States
(12) Patent Application Publication
(10) Pub. No.: US 2016/0182738 A1
(43) Pub. Date: Jun. 23, 2016

(54) WIRELESS ROUTER ASSEMBLY

(71) Applicant: Leonard Alberico, Waltham, MA (US)

(72) Inventor: Leonard Alberico, Waltham, MA (US)

(21) Appl. No.: 14/581,186

(22) Filed: Dec. 23, 2014

(51) Int. Cl. H04M 17/00

(52) U.S. Cl. CPC H04M 17/00

(57) ABSTRACT

A wireless router assembly includes a housing. A card has a first code printed thereon that relates to a pre-determined duration of service time. The first code is entered into an external electronic device. A control circuit is positioned within the housing and a transceiver is positioned within the housing. The transceiver is electrically coupled to the control circuit and is in wireless communication with the external electronic device and an external communications network. The control circuit allows the external electronic device to be in communication with the external communications network for the pre-determined duration of service time when the first code matches a second code. The control circuit prevents the external electronic device from communicating with the external communications network when the first code does not match the second code. An actuator is positioned on the housing to actuate and de-actuate the control circuit.

### BACKGROUND OF THE DISCLOSURE

1. Field of the Disclosure

The disclosure relates to router devices and more particularly pertains to a new router device for providing pre-paid internet access.

2. Summary of the Disclosure

An embodiment of the disclosure meets the needs presented above by generally comprising a housing. A card has a first code printed thereon that relates to a pre-determined duration of service time. The first code is entered into an external electronic device. A control circuit is positioned within the housing and a transceiver is positioned within the housing. The transceiver is electrically coupled to the control circuit and is in wireless communication with the external electronic device. The transceiver is in wireless communication with an external communications network. The control circuit allows the external electronic device to be in communication with the external communications network for the pre-determined duration of service time when the first code matches a second code. The control circuit prevents the external electronic device from communicating with the external communications network when the first code does not match the second code. An actuator is positioned on the housing and the actuator is electrically coupled to the control circuit. The actuator actuates and de-actuates the control circuit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a wireless router assembly according to an embodiment of the disclosure.

FIG. 2 is a bottom view of an embodiment of the disclosure.

FIG. 3 is a right side view of an embodiment of the disclosure.

FIG. 4 is a cross sectional view taken along line 4-4 of FIG. 2 of an embodiment of the disclosure.

FIG. 5 is a schematic view of an embodiment of the disclosure.

### DESCRIPTION OF THE PREFERRED EMBODIMENT

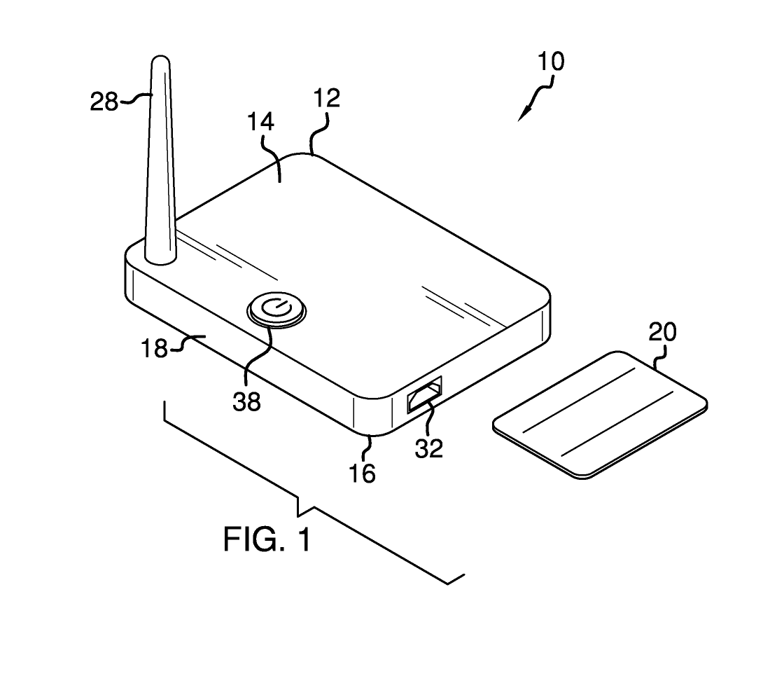

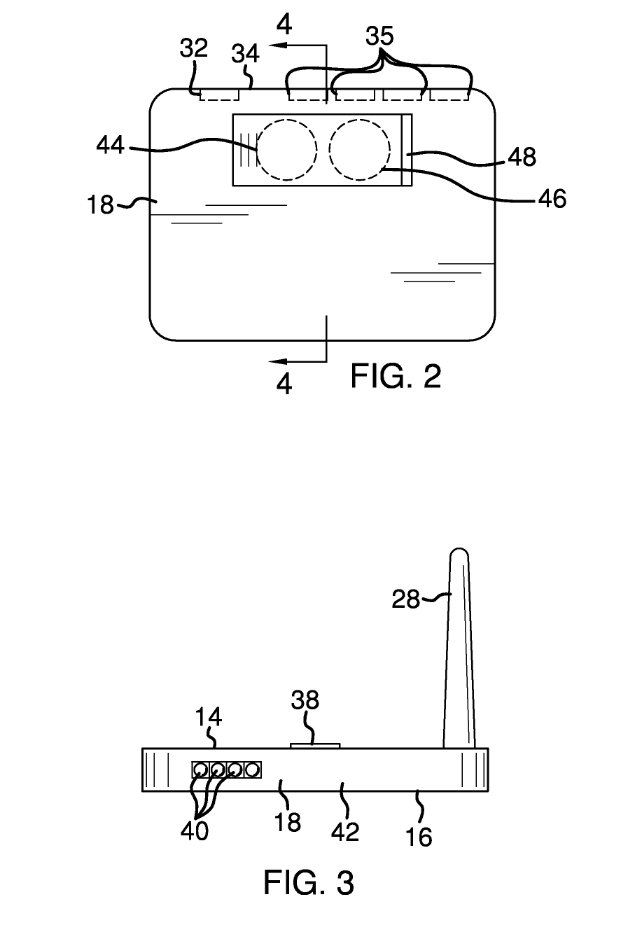

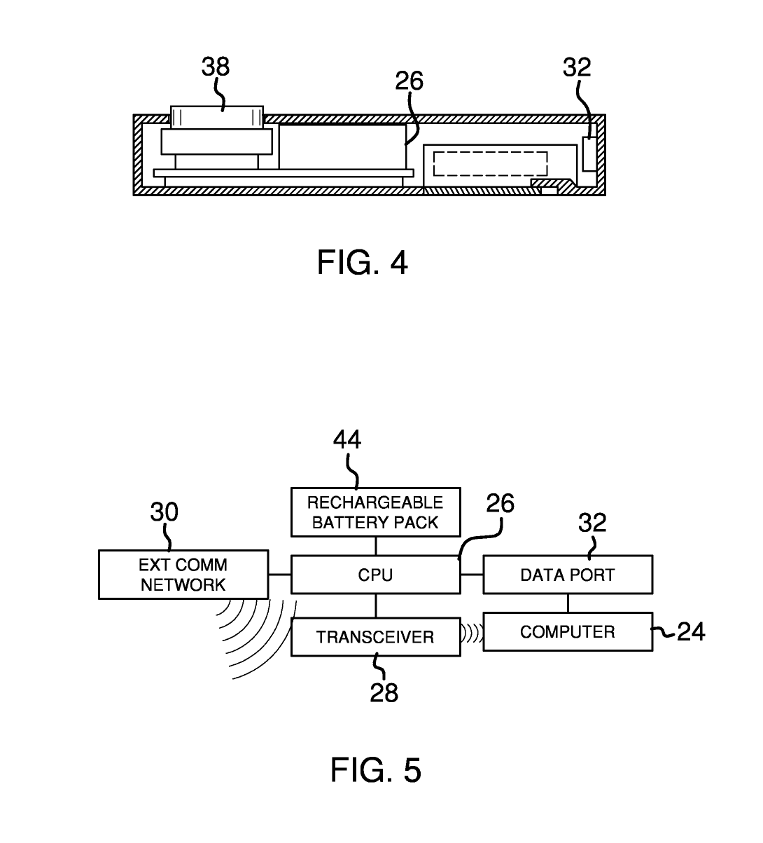

With reference now to the drawings, and in particular to FIGS. 1 through 5 thereof, a new router device embodying the principles and concepts of an embodiment of the disclosure and generally designated by the reference numeral 10 will be described.

As best illustrated in FIGS. 1 through 5, the wireless router assembly 10 generally comprises a housing 12 that has a top wall 14, a bottom wall 16 and a peripheral wall 18 extending therebetween. A card 20 is provided that has a first code printed thereon that relates to a pre-determined duration of service time. The first code may be is entered into an external electronic device 24. The external electronic device 24 may be a personal computer or the like.

A control circuit 26 is positioned within the housing 12 and a transceiver 28 is positioned within the housing. The transceiver 28 is electrically coupled to the control circuit 26 and the transceiver 28 is in wireless communication with the external electronic device 24. The transceiver 28 is additionally in wireless communication with an external communications network 30. The transceiver 28 may be a radio frequency transceiver or the like. The external communications network 30 may be the internet, a cellular phone network, or the like.

A data port 32 is coupled to the housing 12 and is electrically coupled to the control circuit 26. The data port 32 may be positioned on a back side 34 of the peripheral wall 18. The data port 32 has the external electronic device 24 electrically coupled thereto if the external electronic device 24 is not capable of wireless communication with the transceiver 28. The data port 32 may be an Ethernet port or the like. Additionally, the data port 32 may be one of a plurality of data ports 35. The plurality of data ports 35 may comprise a set of LAN ports, a WAN port and a USB port or the like.

An electronic memory 36 is positioned within the housing 12 and the electronic memory 36 is electrically coupled to the control circuit 26. The electronic memory 36 contains a second code. The electronic memory 36 compares the second code with the first code when the first code is entered into the external electronic device 24. The control circuit 26 allows the external electronic device 24 to be in communication with the external communications network 30 for the pre-determined duration of service time when the first code matches the second code. Moreover, the control circuit 26 prevents the external electronic device 24 from communicating with the external communications network 30 when the first code does not match the second code.

An actuator 38 is positioned on the top wall 14 of the housing 12. The actuator 38 is electrically coupled to the control circuit 26 to actuate and de-actuate the control circuit 26. A plurality of light emitters 40 may be coupled to a first lateral side 42 of the peripheral wall 18. The light emitters 40 are electrically coupled to control circuit 26 such that each of said light emitters 40 illuminates when data is transferred between the external communications network 30 and the external electronic device 24.

A power supply 44 is positioned within the housing 12 and the power supply 44 is electrically coupled to the actuator 38. The power supply 44 comprises at least one battery 46. A battery cover 48 is removably coupled to the bottom wall 16. The power supply 44 is positioned beneath the battery cover 48.

In use, the assembly 10 is utilized to provide internet access to the external electronic device 24. The first code is entered into the external electronic device 24. The external electronic device 24 is placed in communication with the external communication network 30 until the pre-determined duration of service time expires. Additional cards 20 are purchased when the pre-determined duration of service time has expired. The first code is entered into the external electronic device 24 each time an additional card 20 is used to purchase internet access.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wireless router assembly configured to provide pre-paid access to a wireless network, said assembly comprising:
a housing;
a card having a first code printed thereon, said code relating to a pre-determined duration of service time, said first code being configured to be entered into an external electronic device;
a control circuit positioned within said housing;
a transceiver positioned within said housing, said transceiver being electrically coupled to said control circuit, said transceiver being configured to be in wireless communication with the external electronic device, said transceiver being configured to be in wireless communication with an external communications network, said control circuit being configured to allow said external electronic device to be in communication with the external communications network for the pre-determined duration of service time when said first code matches a second code, said control circuit being configured to prevent said external electronic device from communicating with the external communications network when said first code does not match said second code; and
an actuator positioned on said housing, said actuator being electrically coupled to said control circuit, said actuator actuating and de-actuating said control circuit.

2. The assembly according to claim 1, further comprising an electronic memory positioned within said housing, said electronic memory being electrically coupled to said control circuit, said electronic memory containing said second code, said electronic memory comparing said second code with said first code when said first code is entered into the external electronic device.

3. The assembly according to claim 1, further comprising a power supply positioned within said housing, said power supply being electrically coupled to said actuator, said power supply comprising at least one battery.

4. The assembly according to claim 1, further comprising a data port coupled to said housing, said data port being electrically coupled to said control circuit, said output being configured to have said external electronic device electrically coupled thereto.

5. A wireless router assembly configured to provide pre-paid access to a wireless network, said assembly comprising:
a housing;
a card having a first code printed thereon, said code relating to a pre-determined duration of service time, said first code being entered into an external electronic device;
a control circuit positioned within said housing;
a transceiver positioned within said housing, said transceiver being electrically coupled to said control circuit, said transceiver being in wireless communication with said external electronic device, said transceiver being configured to be in wireless communication with an external communications network;
an output coupled to said housing, said output being electrically coupled to said control circuit, said output having said external electronic device electrically coupled thereto;
an electronic memory positioned within said housing, said electronic memory being electrically coupled to said control circuit, said electronic memory containing a second code, said electronic memory comparing said second code with said first code when said first code is entered into said external electronic device, said control circuit being configured to allow said external electronic device to be in communication with the external communications network for the pre-determined duration of service time when said first code matches said second code, said control circuit being configured to prevent said external electronic device from communicating with the external communications network when said first code does not match said second code;
a actuator positioned on said housing, said actuator being electrically coupled to said control circuit, said actuator actuating and de-actuating said control circuit; and
a power supply positioned within said housing, said power supply being electrically coupled to said actuator, said power supply comprising at least one battery.
